(19) United States
(12) Patent Application Publication
(10) Pub. No.: US 2026/0365544 A1
(43) Pub. Date: Nov. 19, 2026

(54) Bog Filter

(71) Applicants: Amy Elaine Eikner, Katy, TX (US); Jacob Lee Capetillo, Katy, TX (US)

(72) Inventors: Amy Elaine Eikner, Katy, TX (US); Jacob Lee Capetillo, Katy, TX (US)

(21) Appl. No.: 19/644,806

(22) Filed: Apr. 10, 2026

Related U.S. Application Data
(63) Continuation-in-part of application No. 19/055,076, filed on Feb. 17, 2025, now abandoned.

(51) Int. Cl. C02F 1/00; C02F 1/32; C02F 3/00; C02F 9/00; C02F 103/00

(52) U.S. Cl. CPC C02F 1/001; C02F 1/32; C02F 3/00; C02F 9/00; C02F 2103/007; C02F 2201/007; C02F 2201/009

(57) ABSTRACT

The disclosed and claimed bog filter system is capable of filtering waste from a body of water creating a healthier ecosystem for the body of water. The bog filter system can be powered through solar panels and a battery to store additional energy. The bog filter system includes a pump to extract water and transfer the water to a manifold. The extracted water then exits the manifold into a series of semi-porous materials and filters into a water containment unit for containing the filtered water. The water containment unit includes a second pump, wherein the second pump pumps the filtered water through a chamber for exposing the water to a sanitizing ultraviolet light. The bog filter system is portable, self-contained and designed to operate on a continuous and extended time basis by recirculating and refiltering the body of water to remove waste and pollutants from the body of water.

### CROSS-REFERENCE TO RELATED APPLICATIONS

This application claims benefit to and is a continuation in part of U.S. application Ser. No. 19/055,076 filed on Feb. 17, 2025.

### STATEMENT REGARDING FEDERALLY SPONSORED RESEARCH

Not applicable.

### BACKGROUND

There is a need for portable, off-grid, and self-contained water filtration systems for bodies of water, such as lakes, ponds, or rivers. Clean water is a critical necessity for life and after flooding or severe weather events or even just in remote locations, clean water may not be readily available for humans, farm animals, wildlife, or plants living in or around bodies of water, e.g. lakes, ponds, or rivers. Additionally, human activity such as littering or just road debris being swept into local lakes, ponds, and rivers introduce pollution and contaminants into the bodies of water potentially making the water unsafe for human or animal consumption or exposure. Additionally, with climate-change related weather events causing an increase in flooding, storms, and other natural disasters, there is a need to be able to deploy self-contained and off-grid (e.g. is capable of operating without the need for fossil fuels (oil, gasoline, diesel, natural gas, propane, etc.) or connecting the device to an electrical grid) water filtration systems, such as the disclosed and claimed bog filter system, after these events to generate and reclaim bodies of water and remove pollutants, contaminants, and other biological wastes.

Additionally, remote land ownership or leasing can carry with it the issue of access to, or the lack thereof, potable or clean water. Drilling water wells can be prohibitively expensive for some locations, if even feasible or viable in such remote locations. Remote land ownership or leasing also carries with it the lack of access to electricity or fuel sources for operating electrical and mechanical devices. There is a need for a portable, self-contained, and off-grid water filtration system to produce cleaner water in man-made or pre-existing bodies of water, e.g. lakes, ponds, or rivers. Additionally, some bodies of water may not be suitable for wildlife or plants, there is a need to filter water and generate clean water in such bodies of water to foster a healthier environment for wildlife, plants, and farmed animals, including stocking fish.

Additionally, there is a need to remove contaminants and pollutants from bodies of water to generate clean water for swimming and other aquatic activities. The present bog filter system achieves these goals through its innovative portable, self-contained, and off-grid water filtration system.

### SUMMARY

The disclosed and claimed bog filter system is capable of filtering waste from a body of water, e.g., a lake, pond, or river, thus creating a healthier ecosystem for the body of water. The bog filter system can be powered through one or more solar panels and may optionally include a battery to store additional energy generated by the one or more solar panels. The bog filter system can operate at less than 100 percent or full capacity for solar energy generation or battery storage banks, but preferably the bog filter system powers on for filtering operations once the solar energy generation reaches full capacity and/or the battery storage bank reaches full capacity. It should be appreciated that various configurations and optimizations can be achieved by modifying the start and stop of filtering operations to different energy generation levels or capacity levels.

The bog filter system includes a pump to extract water from the body of water and transfer the extracted water to a manifold. The extracted water then exits the manifold into a series of semi-porous materials, e.g. pea gravel, lava rock, sand, or other granular materials, and filters into a water containment unit for containing the filtered water. The water containment unit includes a second pump, wherein the second pump pumps the filtered water through a chamber for exposing the pumped, filtered water to a sanitizing ultraviolet light before the sanitized, filtered, pumped water returns to the body of water for recirculation.

The bog filter system is designed and intended to operate on a continuous and extended time basis by recirculating and refiltering the body of water to remove waste and pollutants from the body of water. The bog filter is designed and intended to be portable and self-contained to allow transport and re-use across multiple bodies of water. Additionally, the preferred solar panel operation allows for remote operation without the need for additional fuels or electrical wiring to the bog filter to achieve operation of the bog filtering system.

Some embodiments of the bog filter may include a flotation platform; a structural frame comprising a base frame, one or more vertical structural members, an upper frame, one or more leaves, and one or more solar panels mounted to said one or more leaves; and a filtration module comprising a base, a plurality of walled chambers, and a roof panel, wherein a first walled chamber of the plurality of walled chambers comprises an intake manifold for retrieving contaminated water from a body of water and a rough particulate filter, wherein the rough particulate filter provides a substrate for bacterial colony growth, a second walled chamber operatively connected to the first walled chamber, wherein the second walled chamber comprises a secondary filter to filter water exiting from the first walled chamber, and a sanitizing chamber operatively connected to the second walled chamber, wherein the sanitizing chamber comprises an ultraviolet light source to sanitize the water exiting the second walled chamber, and an outflow manifold to release the filtered and sanitized water into the body of water; wherein the flotation platform is securely fastened to the base frame of the structural frame and the filtration module is securely fastened to the base frame of the structural frame.

Other embodiments may include one or more barrels. Still other embodiments may include a plurality of linkable flotation units. In some embodiments the linkable flotation units each comprise one or more protruding members to mate to another one of said protruding members to form an array of linkable flotation units. In some embodiments the one or more leaves are hingedly mounted to the upper frame. Still other embodiments may include the one or more leaves are operatively connected to a motor for lifting and retracting the leaves via the hinged mounts. Additional embodiments may include the filtration module further comprising one or more pumps, filter modules, sensors, microcontrollers, solar panel power/control modules, or batteries. Still other embodiments may include a filtration module further comprising a port for routing treated, nutrient rich water away from the body of water. Other embodiments may include a filtration module further comprising a chamber for collecting treated, nutrient rich water.

### BRIEF DESCRIPTION OF THE DRAWINGS

FIG. 1 is an isometric view of an embodiment of the described bog filter flotation platform.

FIG. 2 is an isometric view of an embodiment of the described bog filter structural frame for mounting the described solar panels.

FIG. 3 is an exploded, isometric view of the structural frame depicted in FIG. 2.

FIG. 4 is a front, isometric view of an embodiment of the filtration module of the described bog filter.

FIG. 5 is a reverse, isometric view of an embodiment of the filtration module of the described bog filter.

FIG. 6 is an exploded, isometric view of the embodiment shown in FIGS. 4 and 5.

FIG. 7 is a front, isometric view of an embodiment of the described bog filter with a flotation platform, structural frame, and filtration module.

FIG. 8 is reverse, isometric view of an embodiment of the described bog filter of FIG. 7.

### DETAILED DESCRIPTION

One or more illustrative embodiments incorporating the invention disclosed herein are presented below. The inventor has created a revolutionary and novel bog filter system with the goal to improve remote bodies of water and promote healthier ecosystems for plants, wildlife, or farmed animals. Other applications of the present invention can be to clean and filter remote bodies of water where access to fuel or electricity is unavailable or unfeasible due to cost or access constraints. Access to clean and potable water is a critical function for life. The inventors' bog filter system provides an economical, efficient, and portable filtration system to achieve these goals.

In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing embodiments of the disclosure and are not intended to be limiting thereto. Drawings are not necessarily to scale and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless, or essentially meaningless, the definition should be taken from Webster's Dictionary 2024. Definitions and/or interpretations should not be incorporated from other patent applications, patents, or publications, related or not, unless specifically stated in this specification, or if the incorporation is necessary for maintaining validity.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

The present invention, bog filter, provides an off-grid water filtration system that is efficient, economical, and portable. The bog filter disclosed and claimed herein filters and sanitizes water extracted from a body of water and recirculates the filtered and sanitized water back into the body of water. The filtering of the body of water, over time, promotes a healthier environment for the body of water and the plants, wildlife, and farmed animals to use cleaner water for drinking or other life sustaining purposes. Other embodiments of the present bog filter can be used in a manner to extract contaminated or unfiltered water from a body of water and extract such water, filter the water, and deliver the water to a separate container for consumption by humans.

Preferable embodiments of the bog filter are self-contained systems that include floatation devices, such as barrels, plastic vessels or chambers, inflatable floats, and/or ballast, to allow the bog filter to float on top of the body of water being filtered. Some embodiments of the bog filter can be implemented through retrofitted boats, canoes, rafts, or other flotation devices. Still other embodiments can using extended piping to allow the bog filter to operate on land or over the body of water in lieu of flotation devices. Some embodiments may include anchors or ties to keep the bog filter in a desired area of the body of water, such as the center of a lake or near the inlet of a pond. Other embodiments may allow the bog filter to freely float about the body of water.

The bog filter uses a biological filtration method, a mechanical filtration method, and an ultraviolet light sanitization method, each method being powered through the energy generated via solar panels and/or battery storage banks. Some embodiments may use marine batteries to store electrical energy, preferably electrical energy produced via one or more solar panels. The one or more solar panels may be a single faced panel or a bi-facial panel.

The filtration process begins by introducing water extracted from the body of water, e.g. lake, pond, or river, through the biological filtration unit. In some embodiments, the biological filtration unit includes a chamber forming a vertical column wherein the extracted water is forced up and through a porous or semi-porous filtration media. The porous or semi-porous filtration media is preferably a pea gravel, but may include other media types including sand, lava rocks, or similar porous or semi-porous media made from natural sources. The porous or semi-porous filtration media may include a combination of two or more types of porous or semi-porous media. The porous or semi-porous filtration media further provides a substrate for growing beneficial bacteria, which further assists with the filtration and cleaning process of the extracted water.

After exiting the biological filtration media, the water then flow into and through a mechanical filtration unit that may comprise one or more mechanical filters. The mechanical filters may comprise activated carbon, natural fibers or fibrous media, or combinations of the same. The mechanical filtration unit operates by passing the water through the physical barrier formed by the mechanical filters to separate the water from the impurities carried by the water extracted from the body of water.

After mechanical filtration, the water is then passed to and through an ultraviolet sanitation unit wherein the water is exposed to ultraviolet light to sanitize and eliminate or reduce the presence of microbes, bacteria, fungi, and viruses. After the ultraviolet sanitation unit, the filtered and sanitized water is returned to the body of water, or in some embodiments transferred to a separate container or vessel for storage.

Some embodiments of the bog filter system may include one or more microcontrollers and/or sensors to operate and monitor the one or more solar panels, battery storage banks, the several pumps, and/or filters. Some embodiments of the bog filter system may include a memory storage unit operatively connected to the one or more microcontrollers to store data regarding the sensor readings or other operational data of the bog filter system. Some embodiments of the bog filter system may include a global positioning system transponder electrically connected to the one or more microcontrollers and/or sensors to allow the owner or user of the bog filter to monitor and track the current or historical location of the bog filter, wherein the historical location data may be stored in the memory storage unit.

Some embodiments allow for the extraction of the biological filtration unit and/or mechanical filtration unit to remove the filtered waste products which can then be processed and used as biological fuels or fertilizers.

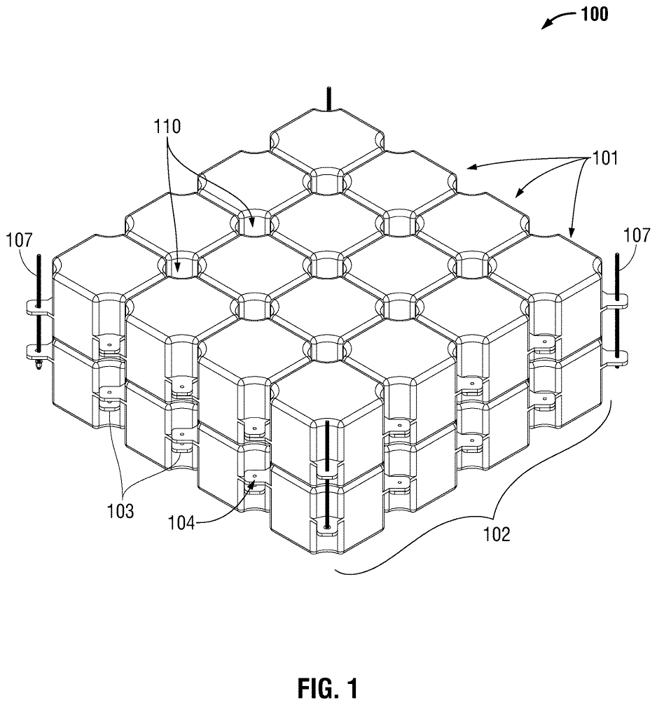

In FIG. 1, some embodiments of the bog filter include a flotation platform 100, such a flotation platform may include a plurality of linkable units 101 to create array 102. The linkable units may include protruding members 103 having a through hole 104 formed thereon for linking to other protruding members 103 of other linkable units 102. Some embodiments may include protruding members 103 that matingly engage with offset protruding members or have receiving slots for reception of the protruding members. Some embodiments may secure the linkable units via fasteners, string, wire, snapfit connections, friction fit connections, or other manners known in the art for joining linkable units to create an array of units. Other embodiments may include one or more barrels linked together to achieve a flotation platform. It should be appreciated that the flotation platform may include ballast to prevent capsizing. Additionally, the flotation platform preferably includes securing mounts or bolts 107 to attach a filtration module, structural frame, or both. Preferably the flotation platform includes, within an interior portion of the platform, one or more through holes or cavities 110 for intake pipes, exit pipes, or tubes to traverse. Alternative embodiments may route such intake pipes, exit pipes or tubes along an exterior surface of the flotation platform. Still other alternative embodiments may incorporate the water intake and exit manifolds into the structure body of the flotation platform rather than using a separate pipe or tube.

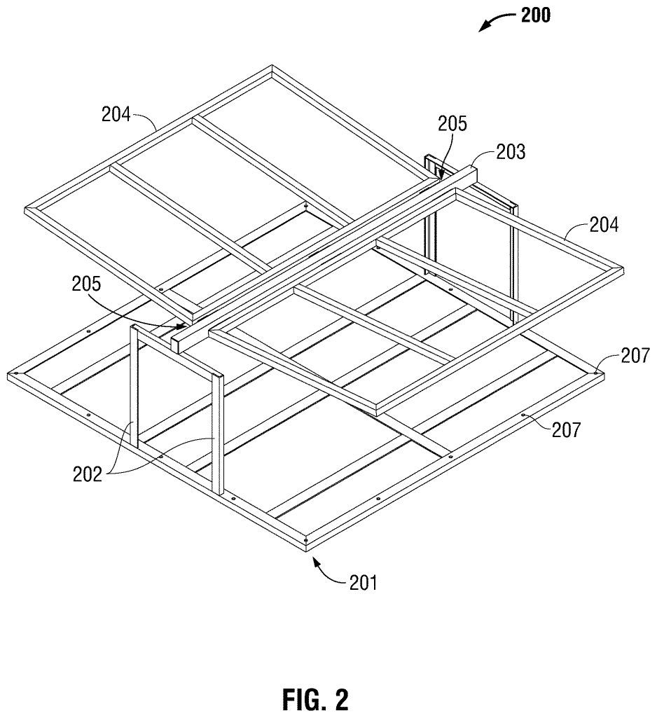

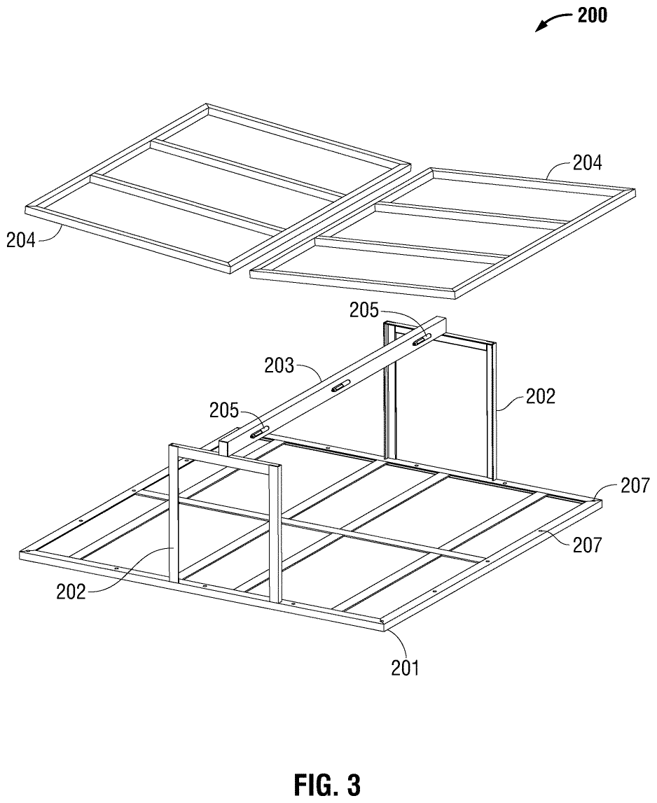

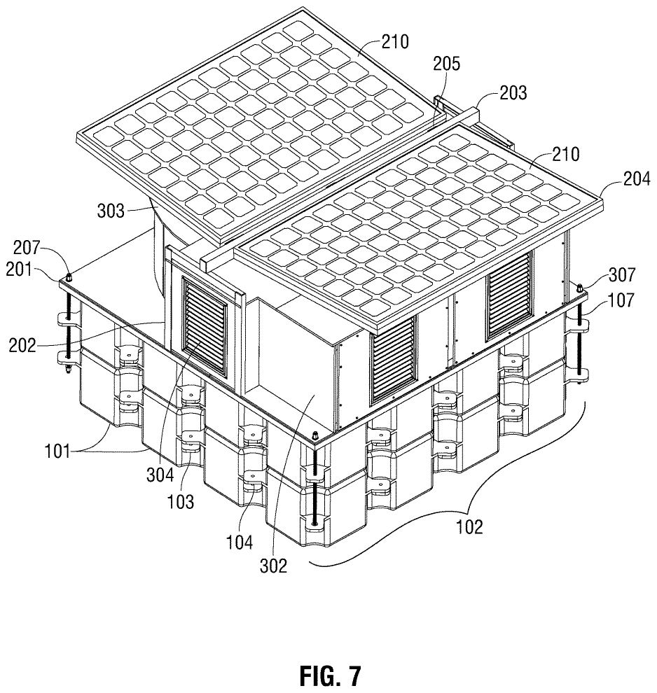

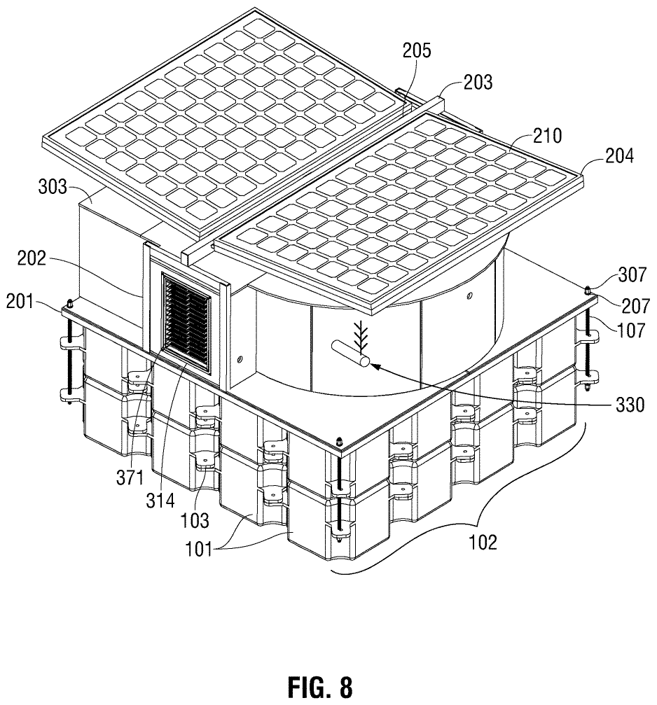

In FIG. 2, some embodiments of the bog filter may include a structural frame 200. Wherein, the structural frame includes a base frame 201 with through hole 207 for mounting or attaching to the flotation platform depicted in FIG. 1. The structural frame may also include vertical structural members 202 for mounting or attaching of one or more filtration modules. The vertical structural members may also be used to hold or support an upper frame 203, preferably comprising one or more leaves 204 for mounting or attaching one or more solar panels or solar arrays 210 (shown in FIGS. 7 and 8). In some embodiments, the leaves are hinge mounted 205 to the upper frame and may include a motor to lift and retract the one or more leaves. Such hinged movement can allow for more compact storage or portability, directing a solar panel or solar array to a more optimal position for collection of solar energy, or both. In some embodiments, the hinge mounts allow for removal and installation of the leaves providing easier replaceability, servicing, or portability. FIG. 3 shows an alternative, exploded view of the structure described above.

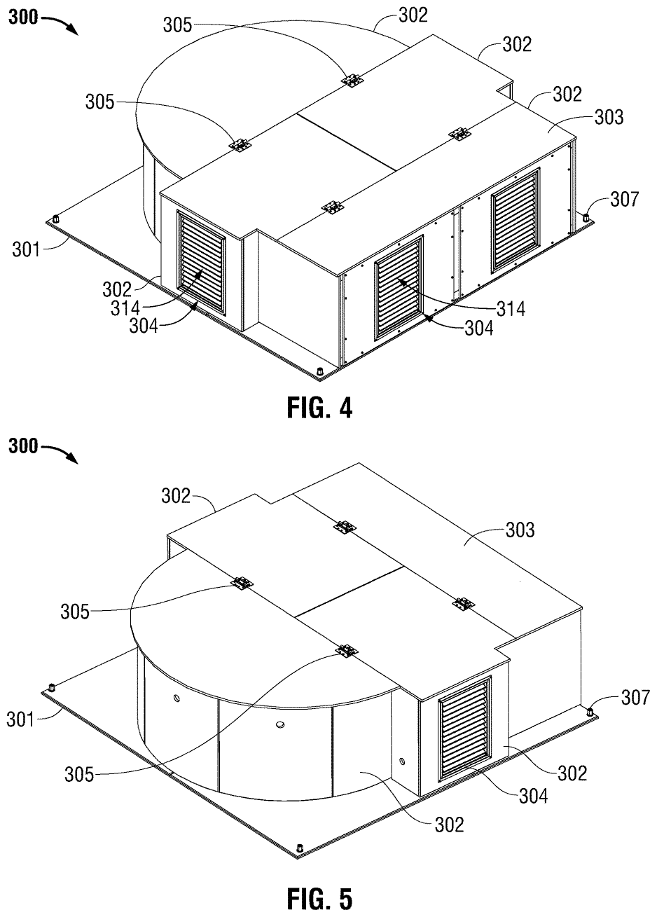

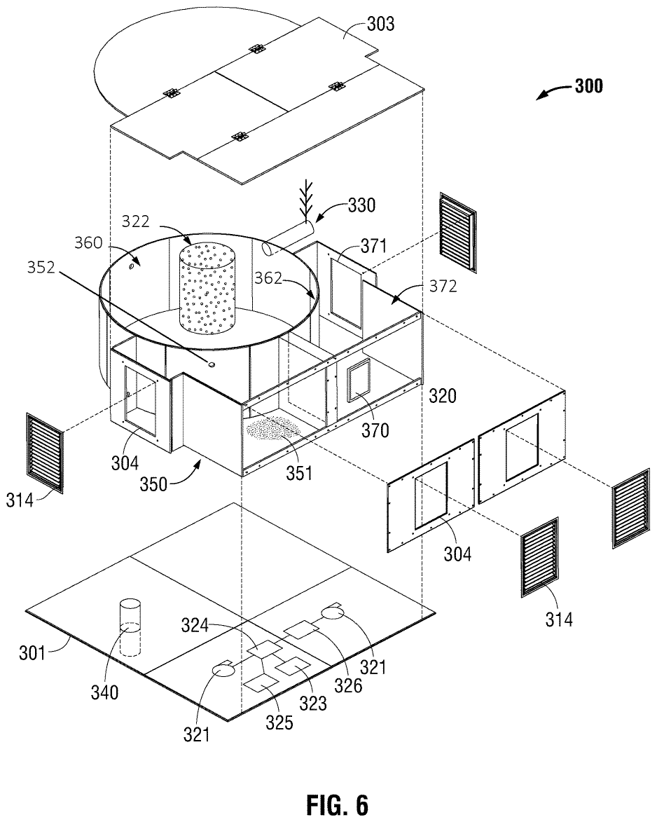

In FIGS. 4, 5, and 6, the bog filter filtration module 300 is shown having a base 301, multiple walled chambers 302, and one or more panels forming a roof 303. In some embodiments, the filtration module is preferably structured to slide within the structural frame and then secured to the structural frame via through holes 307, which is likewise secured to the flotation platform. Some embodiments may include attachments, such as bolts 107 that join all three portions, flotation platform, structural frame, and filtration module into a singular unit. Also shown are walled chambers 302. The walled chambers may have formed on a surface a through hole or cavity 304 allowing for intake or exit of air, water, or retrieval of filtered containments. Additionally, the one or more panels forming the roof 303 may be joined 305 via hinges, joints, or affixed directly to the walled chambers via fasteners, string, wire, snapfit connections, friction fit connections, or other manners known in the art for joining panels to walled structures. Some embodiments may include filter ports 314 for entry or exit of air or water, wherein a filter is mounted to or on the through hole or cavity formed in the walled chamber. Some embodiments may include one or more chambers 320, 350, 360, 372 for housing one or more pumps 321, filter modules 322, sensors 323, microcontrollers 324, solar panel power/control module 325, or battery units 326 for storing solar generated energy to allow operation of the bog filter in non-sunny conditions, e.g. overnight or cloudy days. Other embodiments may include one or more chambers for collection or exfiltration of waste products, such as filtered organic or inorganic matter and preventing such matter from being reintroduced into the body of water being filtered by the bog filter. Other embodiments may include a port or chamber 330 for capturing or routing treated, nutrient rich water to plants, fish stock tanks, or for other livestock or crop usage.

In some embodiments, the bog filter includes a pump 321 to draw in water from a body of water into a manifold 340 into an initial filtration chamber 350 comprising pea gravel and filters 351. The initial chamber provides rough particulate filtering by running the drawn in water through or over the pea gravel or other material. The pea gravel layer may be comprised of pea gravel or other natural porous filtration media for providing a substrate for beneficial bacterial colony growth. Finer particles are filtered by a secondary filter, such as a mechanical filter comprising activated carbon and/or natural fibers, after passing through the pea gravel. In some embodiments, the water is drawn into the initial filtration chamber wherein it first passed through a bottom layer of pea gravel, continues to percolate up through the chamber through a secondary filter 322, the filtered water can then flow into a water containment chamber or second walled chamber. In some embodiments, the drawn in water then exits the initial filtration chamber and enters a water containment chamber via a pump or gravity filtration through connection 352 wherein a secondary filter 322 may further filter the drawn in water. A second pump 321 may be housed within the water containment chamber or operatively connected to the water containment chamber. The second pump then pumps the contained water through a chamber or passage 372 via connection 362 (obscured) exposing the pumped water to ultraviolet light 370 to sanitize the pumped water before returning the filtered and sanitized water through an outflow manifold 371 to the body of water.

FIGS. 7 and 8 depict a preferred embodiment of the bog filter wherein the flotation platform, structural frame with solar array 210, and filtration module are joined into a comprehensive unit.

Some embodiments of the bog filter system may include an alternating current to direct current inverter to convert direct current from the one or more solar panels and/or battery storage banks to alternating current to power the pumps, microcontroller, and/or sensors.

It should be appreciated that the disclosure and teachings of the several embodiments described herein may be used interchangeably to achieve different embodiments not explicitly depicted. Accordingly, it is intended that the following claims be interpreted to embrace all such variations and modifications.

What is claimed is the following:

1. A bog filter system comprising:
a flotation platform;
a structural frame comprising a base frame, one or more vertical structural members, an upper frame, one or more leaves, and one or more solar panels mounted to said one or more leaves; and
a filtration module comprising a base, a plurality of walled chambers, and a roof panel, wherein a first walled chamber of the plurality of walled chambers comprises an intake manifold for retrieving contaminated water from a body of water and a rough particulate filter, wherein the rough particulate filter provides a substrate for bacterial colony growth, a second walled chamber operatively connected to the first walled chamber, wherein the second walled chamber comprises a secondary filter to filter water exiting from the first walled chamber, and a sanitizing chamber operatively connected to the second walled chamber, wherein the sanitizing chamber comprises an ultraviolet light source to sanitize the water exiting the second walled chamber, and an outflow manifold to release the filtered and sanitized water into the body of water;
wherein the flotation platform is securely fastened to the base frame of the structural frame and the filtration module is securely fastened to the base frame of the structural frame.

2. The bog filter system of claim 1, wherein the flotation platform comprises a plurality of linkable flotation units.

3. The bog filter system of claim 2, wherein the linkable flotation units each comprise one or more protruding members to mate to another one of said protruding members to form an array of linkable flotation units.

4. The bog filter system of claim 1, wherein one or more leaves are hingedly mounted to the upper frame.

5. The bog filter system of claim 1, wherein the filtration module further comprises one or more pumps, sensors, microcontrollers, solar panel power/control modules, or batteries.

6. The bog filter system of claim 1, wherein the filtration module further comprises a port for routing treated, nutrient rich water away from the body of water.
